(19) United States
(12) Patent Application Publication
(10) Pub. No.: US 2023/0173898 A1
(43) Pub. Date: Jun. 8, 2023

(54) Pickup Truck Bed Solar Cover System

(71) Applicant: Lee Dawson, Champions Gate, FL (US)

(72) Inventor: Lee Dawson, Champions Gate, FL (US)

(21) Appl. No.: 17/933,893

(22) Filed: Sep. 21, 2022

Related U.S. Application Data
(60) Provisional application No. 63/286,603, filed on Dec. 7, 2021.

(51) Int. Cl. B60J 7/08; B60R 16/033; H02S 40/38; H02J 7/35; H02S 20/30

(52) U.S. Cl. CPC B60J 7/08; B60R 16/033; H02S 40/38; H02J 7/35; H02S 20/30

(57) ABSTRACT

The present invention relates to an improved, multifunctional truck bed cover system. The truck bed cover system comprises a plurality of solar panels embedded in a primary truck bed cover and an additional two to three panels configured to be deployed over a cab of the truck using an aluminum frame. The primary truck bed cover is configured to be pivotally movable and inclines using a pair of hinged arms, the hinged arms have movable members that laterally move along channels positioned on sidewalls of the truck bed to incline and decline the truck bed cover. The system can recharge the main battery of the truck and can also recharge an optical or auxiliary battery coupled to an inverter for providing electric power to external items connected to a power socket positioned in the truck bed.

### CROSS-REFERENCE TO RELATED APPLICATION

The present application claims priority to, and the benefit of, U.S. Provisional Application No. 63/286,603, which was filed on Dec. 7, 2021 and is incorporated herein by reference in its entirety.

### FIELD OF THE INVENTION

The present invention relates generally to the field of electric pickup trucks and solar charging systems. More specifically, the present invention relates to an improved, multifunctional truck bed cover comprised of solar panel collectors embedded into the top of the cover. Additional solar panels are also provided for absorbing solar energy. The solar energy is converted into electric power and trickled to the main battery pack of the truck or to an optical or auxiliary battery pack and inverter for off-site or off-grid electrical needs. The cover and additional panels are pivotable to orient as per preferences of pickup truck riders. Accordingly, the present disclosure makes specific reference thereto. Nonetheless, it is to be appreciated that aspects of the present invention are also equally applicable to other like applications, devices, and methods of manufacture.

### BACKGROUND

By way of background, the light duty pickup truck is a popular motor vehicle in the U.S. and in many other parts of the world as well. Such vehicles carry a limited number of passengers, as well as a relatively large volume of cargo, accounting for their popularity with motor vehicle owners and operators. The pickup trucks are popular with small business owners, construction contractors, and others in similar fields. Pick-up trucks are a lifestyle choice in several markets around the world. In the U.S., pickup trucks account for 15-20% of total vehicle sales.

Individuals use pickup trucks for adventurous off-road journeys, taking off to the desert, beaches and more. The truck bed provides space for cargo and gives a place to accommodate passengers. Recently, electric pickup trucks have become a reality and are commercially available. Electric pickup trucks have a standard electric vehicle battery for providing power to the truck. However, users of electric pickup trucks face a challenge in travelling long distances using such trucks because of lack of charging stations, especially when trucks are used off roads or in remote areas. Lack of power provided by the battery after running a predetermined distance can cause the truck to strand in potentially dangerous areas and place passengers in a dangerous situation. Individuals desire a way that can provide additional electric power to a battery of an electric pickup truck and enables users to travel long distances without requiring frequent charging of the battery.

Batteries of pickup trucks are generally used by individuals to power electric tools, such as, a generator, radio, and more while remote at a campsite, a worksite and more. A low battery charge of an electric pickup truck may be unable to provide power to operate several devices desired by users. Individuals desire a means to improve battery life of the electric pickup trucks, while enabling users to operate tools from power drawn from the batteries of electric pickup trucks.

A common problem with electric pickup trucks is that conventional gasoline cannot be used for charging the battery and providing power to the truck. Users require electric power to recharge the battery which is generally provided by the electric charging stations. Frequent stopping at charging stations also delays a trip. Individuals desire a sustainable way of recharging batteries and/or providing electric power to tools using the batteries of electric pickup trucks.

Therefore, there exists a long-felt need in the art for a power source that can be used for charging the integrated battery of an electric pickup truck. There is also a long-felt need in the art for an electric power source that can be integrated or retrofitted to pickup trucks. Additionally, there is a long-felt need in the art for a power source that reduces dependency of electric pickup trucks on charging stations for charging the integrated battery. Moreover, there is a long-felt need in the art for a power source that enables passengers to travel long distances in electric pickup trucks without frequent stops at charging stations. Further, there is a long-felt need in the art for a novel power source for electric pickup trucks that can power external items like generators, radios, power tools, and more. Finally, there is a long-felt need in the art for an additional power source that functions as a means of additional power for electric pickup trucks, ensuring the trucks do not run out of battery charge during long trips.

The subject matter disclosed and claimed herein, in one embodiment thereof, comprises a solar charging system for electric pickup trucks. The system is used for trickling a charge to the main battery or batteries of a truck and for providing power to external items like generators, radios, power tools, and more. The system further comprises a plurality of solar panels positioned on a top surface of a truck bed cover, an additional plurality of solar panels positioned above the cab of the truck and supported by an aluminum frame extending from the truck bed, wherein the plurality of solar panels include photovoltaic cells for absorbing a solar energy and converting the into direct current (DC) electric power, an optical or auxiliary battery pack for storing said electric power, and an inverter connected to the battery pack for converting said DC power into AC power, wherein the bed cover rests on the side walls, rear wall and front wall of the truck bed and is configured to incline using a hinge system. The DC power can be used for recharging the main battery of the truck and the AC power can be used for providing power to external items.

In this manner, the solar panels charging system of the present invention accomplishes all of the foregoing objectives and provides users with a unique truck bed cover comprised of solar panels for absorbing sunlight and converting it into electric power which is stored in the vehicle battery. The solar panels provide additional electric energy to the electric pickup truck and can also be used for powering external items like generators, radios, power tools, and more. The solar panels enable an electric pickup truck to travel long distances without requiring frequent charging at charging stations.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a solar charging system for electric pickup trucks. The system further comprising a plurality of solar panels positioned on a top surface of a truck bed cover, a plurality of additional solar panels positioned above the cab of the truck and supported by an aluminum frame extending from the truck bed, the solar panels including photovoltaic cells for absorbing solar energy and converting into direct current (DC) electric power, an optical or auxiliary battery pack for storing said electric power, an inverter connected to the battery pack for converting said DC power into AC power, wherein the bed cover rests on the side walls, rear wall, and front wall of the truck bed and is configured to incline using a hinge system.

In yet another embodiment, the truck bed cover includes a pair of longitudinal edges forming side edges and a pair of lateral edges forming a rear edge and a front edge.

In yet another embodiment, the hinge system includes a pair of hinged arms, each hinged arm extends from a hinge positioned at a junction of the front edge and a longitudinal edge and a movable member wherein the movable member is configured to laterally move along a channel disposed along top edge of the sidewall of the truck bed.

In yet another embodiment, the cover inclines when the movable members move toward the front wall of the truck bed and the cover declines when the movable members move toward the rear wall of the truck bed.

In yet another embodiment, a solar charging system for recharging the main battery of an electric pickup truck is disclosed. The system includes a plurality of solar panels configured to absorb solar energy and function as a truck bed cover, the solar panels are coupled to the main battery of the truck and are configured to convert solar energy into electric power, wherein said electric power is stored in the main battery to recharge the battery.

In yet another embodiment, an electric pickup truck solar bed cover system for providing AC electric power to run, for example, a campsite and/or a worksite is disclosed. The system includes a plurality of solar panels for absorbing solar energy for conversion into electric energy, a battery pack for storing said electric energy, an inverter coupled to said battery pack for converting said stored electric energy into alternating current power, a power socket for receiving an alternating current power from said inverter for providing to a plugged in campsite and/or worksite tools wherein the battery pack is also configured to provide stored electric energy to a main battery pack of the electric pickup truck.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of an electric pickup truck equipped with one potential embodiment of the pickup truck solar bed cover of the present invention in accordance with the disclosed architecture;

FIG. 2 illustrates a rear perspective view of the electric pickup truck with the flat cover positioned in an inclined position using a hinge system in accordance with the disclosed architecture;

FIG. 3 illustrates an enlarged view of the mechanism showing pivotal movement of the flat cover in accordance with the disclosed architecture;

FIG. 4 illustrates a perspective view showing a position of the aluminum support of additional solar panels when the additional solar panels are not required in accordance with the disclosed architecture;

FIG. 5 illustrates a side perspective view of a pickup truck equipped with a solar bed cover showing movement of the solar cover from a substantially horizontal position to an inclined position in accordance with the disclosed architecture; and

FIG. 6 illustrates a generic functional block diagram showing the electrical connection of the solar panels with the main battery of the pickup truck and optical or auxiliary battery in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a power source that can be used for charging the integrated battery of an electric pickup truck. There is also a long-felt need in the art for an electric power source that can be integrated or retrofitted to pickup trucks. Additionally, there is a long-felt need in the art for a power source that reduces dependency of the electric pickup trucks on charging stations for charging the integrated battery. Moreover, there is a long-felt need in the art for a power source that enables passengers to travel long distances in electric pickup trucks without frequent stops at charging stations. Further, there is a long-felt need in the art for a novel power source for electric pickup trucks that can power external items like generators, radios, power tools, and more. Finally, there is a long-felt need in the art for an additional power source that functions as a means of additional power for electric pickup trucks, ensuring the trucks do not run out of battery charge during long trips.

The present invention, in one exemplary embodiment, is a solar charging bed cover system for recharging the main battery of an electric pickup truck and providing electric power to external items. The system includes a plurality of solar panels configured to absorb solar energy and function as truck bed cover, the solar panels are coupled to the main battery of the truck and are configured to convert solar energy into electric power, wherein said electric power is stored in the main battery to recharge the battery. The solar panels can also be connected to an optical or auxiliary battery coupled to an inverter for providing alternating current to a power socket positioned inside the truck bed for using external items, such as, tools at a worksite and camp items at a campsite.

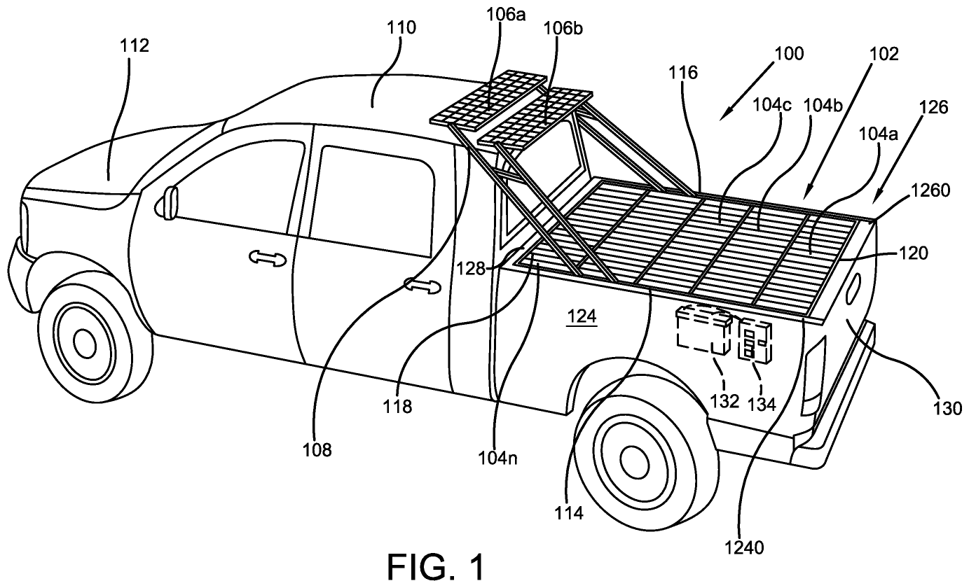

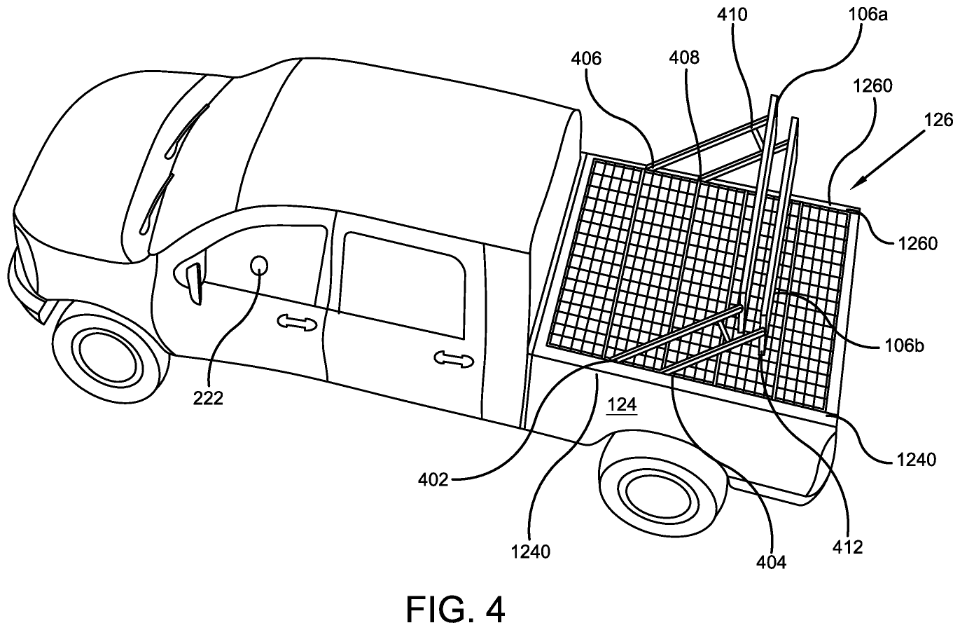

Referring initially to the drawings, FIG. 1 illustrates a perspective view of an electric pickup truck equipped with a pickup truck solar bed cover of the present invention in accordance with the disclosed architecture. The pickup truck solar bed cover 100 of the present invention is designed to cover a pickup truck bed and includes a flat cover 102 comprising a plurality of solar panels 104a-n, for absorbing solar energy and converting it into electric power. The solar bed cover 100 also includes at least two additional solar panels 106a,106b supported by an aluminum frame 108. The additional solar panels 106a,106b are preferably positioned above the cab 110 of the truck 112 and do not cause any drag during motion of the truck 112. The aluminum frame 108 is retractable and foldable and can be re-positioned slightly above the flat solar cover 102, as illustrated in FIG. 4. The electric power converted from solar energy by the panels 104a-n, 106a,106b is either stored in the main battery of the truck 112 or in an optical or auxiliary battery pack as described later in the disclosure.

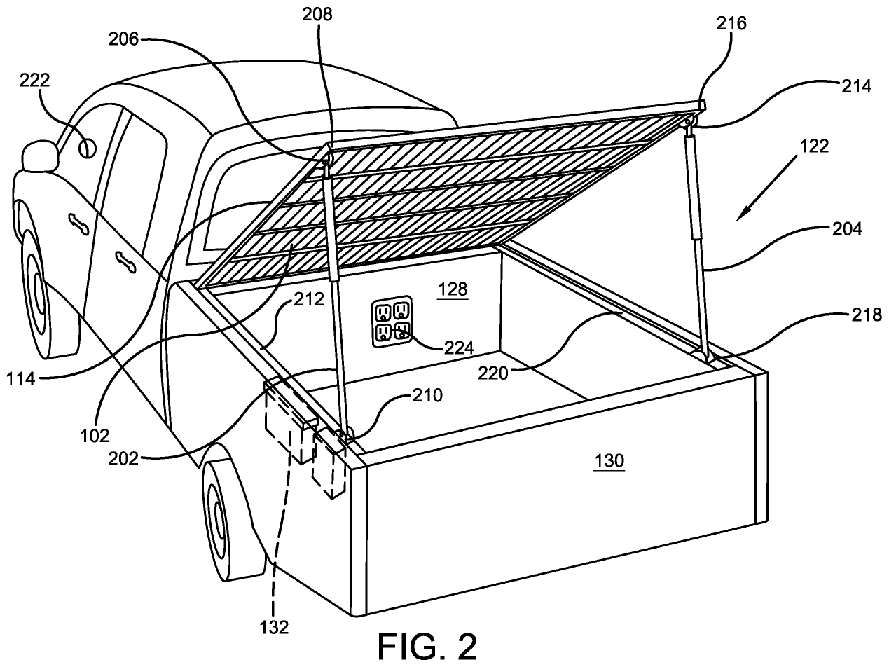

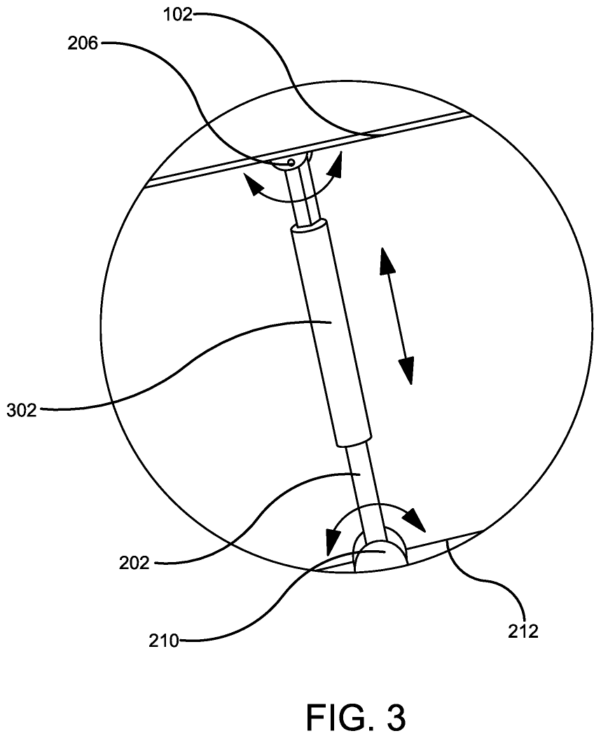

The flat cover 102 has a pair of opposite longitudinal edges 114,116 and a pair of lateral edges 118,120 with the solar panels 104a-n disposed on the top surface of the flat cover 102 for absorbing solar light. The flat cover 102 can be coupled to a motorized hinge system 122 illustrated in FIGS. 2 and 3 allowing the flat cover 102 to incline relative to the truck bed to access the cargo of the truck and any other articles stored in the truck bed.

The flat cover 102 is supported on the sidewalls 124,126, a back wall 128 and a front wall 130 of the truck bed, and the hinge system 122 of the flat cover 102 is positioned underneath the flat cover 102 and along the top edges 1240,1260 of the side walls 124,126.

The flat cover 102 is preferably made of lightweight metal like aluminum and may have a vinyl cover for encapsulating the solar panels 104a-n. Similarly, the frame of the additional solar panels 106a-b is also made from aluminum and has a vinyl cover.

The flat cover 102 is sized and shaped to fit over the bed of the pick-up truck 112 and is designed and configured so that the profile of the truck 112, when the flat cover 102 is installed, is very similar to that of an uncovered bed.

The solar panels 104a-n, 106a-b absorb solar energy and the photovoltaic cells of the solar panels convert the absorbed solar energy into electric power. The electric power can be directly trickled to the main electric battery of the pickup truck 112. Alternatively, the solar charging system 100 can have an optical or auxiliary battery 132 for storing the electric power produced by the solar panels. The optical or auxiliary battery 132 is connected to an inverter 134 allowing conversion of stored direct current (DC) power to alternating current (AC).

The battery 132 and the inverter 134 are installed along with the solar panels and are appropriately positioned inside the pickup truck 112. Further, the solar panels are coupled to the optical or auxiliary battery 132 via conventional wired circuits (not shown) running inside the truck 112.

FIG. 2 illustrates a rear perspective view of the electric pickup truck with the flat cover 102 positioned in an inclined position using a hinge system in accordance with the disclosed architecture. The motorized hinge system 122 of the bed cover 102 includes a pair of hinged arms 202,204 including a first hinged arm 202 and a second hinged arm 204. The first arm 202 extends from a first hinge 206 positioned on the distal end 208 of the longitudinal edge 114 to a moving member 210. The moving member 210 is configured to move along a channel 212 positioned on the side wall 124.

The second arm 204 extends from a second hinge 214 positioned on the distal end 216 of the longitudinal edge 116 to a corresponding moving member 218. The moving member 218 is configured to move along a channel 220 positioned on the side wall 126.

The movement of the moving members 210,218 along the respective channels 212,220 towards the front wall 130 enables the flat cover 102 to incline and movement of the moving members 210,218 towards the rear wall 128 enables the flat cover 102 to decline.

The channels 212,220 form a path for lateral movement of the moving members 210,218, and the hinges 206,214 allow the pivotable movement of the arms 202,204 for pivoting the solar flat cover 102 to allow for access to the truck bed. The motorized hinge system 122 can be activated manually by pulling the solar cover 102 up by moving the moving members 210,218 along the channels. The hinge system 122 can also be operated using a control button 222 positioned appropriately inside the cabin of the truck allowing easy access of the hinge system 122 for controlling movement of the flat cover 102.

The solar charging system 100 provides power sockets 224 positioned inside the truck bed and preferably on the rear wall 128 for drawing power from the optical or auxiliary battery 132 (when the battery 132 is utilized for storing electric power converted from solar energy). The power sockets 224 can be used for plugging in various tools or devices used at campsites, worksites, and more without requiring any additional power source.

FIG. 3 illustrates an enlarged view of the mechanism showing pivotal movement of the flat cover in accordance with the disclosed architecture. As illustrated, the hinge 206 is configured to pivotally turn the hinged arm 202 when the movable member 210 laterally moves along the channel 212 disposed along top edge of a sidewall of the truck bed. The pivotable movement also enables the hydraulic pipe 302 to move along the length of the arm 202 for smooth movement of the flat cover 102 for inclining or declining the solar panels 104a-n disposed on top surface of the flat cover 102.

Primarily, the lateral motion of the movable member 210 causes the turning motion of the hinge 208 to incline or decline the flat cover 102. Motion of both of the hinged arms 202,204 are synchronous using the respective hinges and thus, a smooth movement of the flat cover 102 is achieved as per requirements of a user.

FIG. 4 illustrates a perspective view showing the position of the aluminum support of additional solar panels when the additional solar panels are not required in accordance with the disclosed architecture. The aluminum support 108 is configured to support the additional solar panels 106a-b and is also configured to change the position of the additional solar panels 106a-b when the additional solar panels are not required to be used, due to motion of the truck or due to change in direction of solar light. More specifically, the aluminum frame 108 is attached to the top edges 1240,1260 of the sidewalls 124,126 of the truck bed and has separate arms for supporting the solar panels.

More specifically, the supporting structure 410 is pivotally hinged at hinge 402 on top edge 1240 and hinge 406 on top edge 1260. The hinges 402,406 allow the movement of the solar panel 106a from the deployed position over the cab as illustrated in FIG. 1 to a declined position as illustrated in FIG. 4. Similarly, the supporting structure 412 is pivotally hinged at hinge 404 on top edge 1240 and hinge 408 on top edge 1260. The hinges 404,408 allow the movement of the solar panel 106b synchronously with the movement of the solar panel 106a. The supporting structures 410,412 are coupled to each other enabling movement of the solar panels 106a,106b together.

The aluminum frame 108 can be actuated and move from deployed position (FIG. 1) to declined position (FIG. 3) using the control button 222 positioned inside the cab of the pickup truck.

In one embodiment, the additional solar panels 106a-b can overlay the solar roof 102 when not required. The aluminum frame can be accommodated on the top edges of the 1240,1260 of the side walls 124,126 for allowing the aluminum frame and additional solar panels to overlay the solar roof 102.

In one embodiment of the present invention, the additional solar panels 106a-b and the aluminum frame 108 are removable and can be detached from the pickup truck. Further, the aluminum frame 108 can be designed based on design and configuration of the truck bed and cab of the pickup trucks.

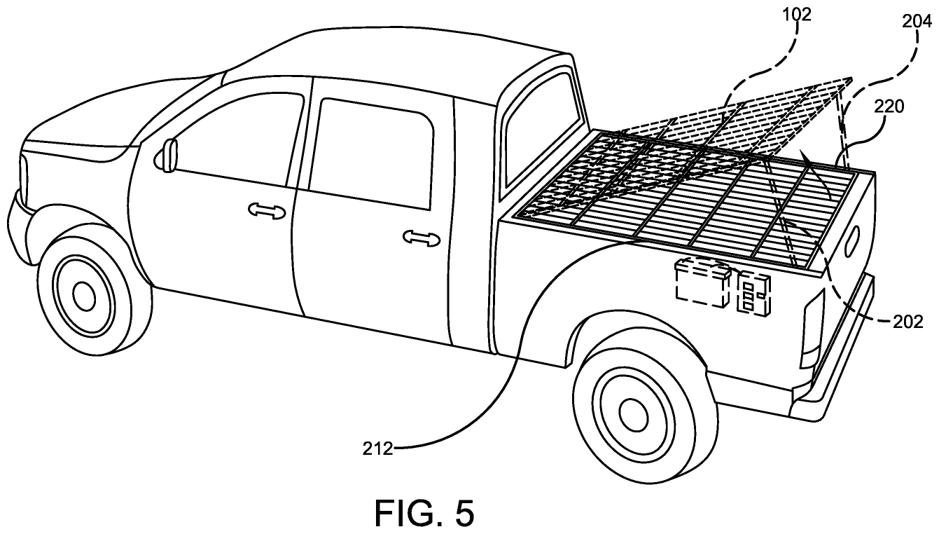

FIG. 5 illustrates a side perspective view of a pickup truck equipped with a solar bed cover 102 showing movement of the solar cover 102 from substantially horizontal position to inclined position in accordance with the disclosed architecture. The hinged arms 202,204 are accommodated underneath the solar roof 102 along the channels 212,220 and when the roof 102 is inclined, the movable members of the arms 202,204 move towards the front wall 130 of the truck bed. This enables the roof 102 to incline and absorb more solar energy for conversion to electric power for use in powering the truck and other tools and devices.

It should be noted that with the incorporation of solar panels 104a-n, 106a-b, optical or auxiliary battery, power sockets, and inverter, the solar charging system 100 can be used for on-demand AC power without the need to use the vehicle's primary battery, thereby increasing total available power and decreasing the risk of drawing down the primary battery during extended power use. Additionally, an entertainment system can be coupled to the optical or auxiliary battery.

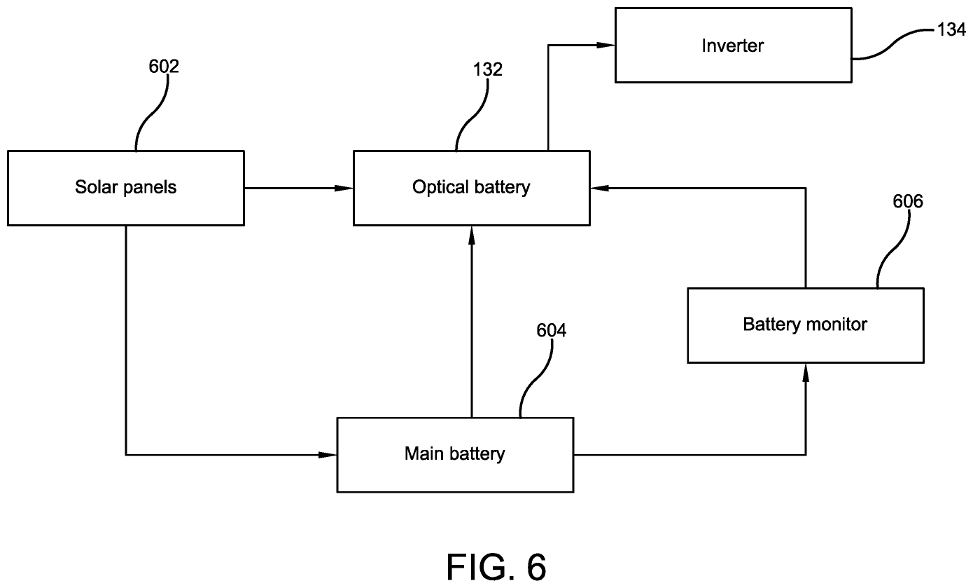

FIG. 6 illustrates a generic functional block diagram showing electrical connection of the solar panels with the main battery of the pickup truck and optical or auxiliary battery in accordance with the disclosed architecture. As illustrated, the solar panels 602 (referred to solar panels 104a-n, 106a-b) are connected to the optical or auxiliary battery 132 and main battery 604 of the vehicle. It should be noted that in some embodiments of the invention, the optical or auxiliary battery 132 may not be required and the solar panels can be attached only to the main battery 604 of the vehicle.

The optical or auxiliary battery 132 stores the electrical power in DC form and is coupled to an inverter 134 allowing conversion to AC power. A battery monitor 606 is also coupled to the main battery 604 and is configured to monitor power level of the main battery 604. In situations where the battery charge level of the main battery 604 is lower than a predetermined threshold (like 40% of total capacity), then an automatic switch can take place from the main battery 604 to the optical or auxiliary battery 132. The cover may also comprise an electronic vehicle solar system control module which conditions current and voltage and integrates with vehicle Battery Control Module (BCM) to increase range.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “pickup truck solar bed cover”, “pickup truck solar charging system”, “electric pickup truck solar bed cover”, and “cover” are interchangeable and refer to the electric pickup truck solar charging system 100 of the present invention.

Notwithstanding the foregoing, the electric pickup truck solar charging system 100 of the present invention can be of any suitable size and configuration as is known in the art without affecting the overall concept of the invention, provided that it accomplishes the above-stated objectives. One of ordinary skill in the art will appreciate that the electric pickup truck solar charging system 100 as shown in the FIGS. are for illustrative purposes only, and that many other sizes and shapes of the electric pickup truck solar charging system 100 are well within the scope of the present disclosure. Although the dimensions of the electric pickup truck solar charging system 100 are important design parameters for user convenience, the electric pickup truck solar charging system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A truck solar bed cover comprising:
a solar bed cover spanning a bed of a truck;
a plurality of solar panels for absorbing a solar energy and comprising a plurality of photovoltaic cells for converting the solar energy into an electric power, wherein said electric power is converted from the solar energy and stored in at least a main battery of the truck and in an auxiliary battery of the truck; and
an aluminum frame, wherein said aluminum frame is retractable and foldable adjacent to said solar bed cover;

2. The truck solar bed cover of claim 1, wherein said solar bed cover comprises a pair of opposite longitudinal edges and a pair of lateral edges having said plurality of solar panels therebetween on a top surface of said solar bed cover.

3. The truck solar bed cover of claim 1, wherein said solar bed cover comprises a motorized hinge system for moving said solar bed cover from a horizontal orientation to an inclined orientation, and further wherein said inclined orientation of said solar bed cover enables access to the bed of the truck.

4. The truck solar bed cover of claim 1, wherein said solar bed cover is supported by a pair of sidewalls, a back wall and a front wall of the bed of the truck.

5. The truck solar bed cover of claim 1, wherein said solar bed cover comprises a lightweight aluminum frame.

6. The truck solar bed cover of claim 1, wherein said solar bed cover comprises a first vinyl cover for selectively encapsulating said plurality of solar panels.

7. The truck solar bed cover of claim 1 further comprising a second vinyl cover for selectively encapsulating a portion of said plurality of solar panels.

8. The truck solar bed cover of claim 1, wherein the electric power is trickled to said main battery of the truck.

9. The truck solar bed cover of claim 8, wherein the electric power is trickled to said auxiliary battery for storing the electric power produced by said plurality of solar panels, and further wherein said auxiliary battery is connected to an inverter for conversion of the stored electric power to an alternating current.

10. The truck solar bed cover of claim 3, wherein said motorized hinged system comprises a first hinged arm and a second hinged arm.

11. The truck solar bed cover of claim 10, wherein said first hinged arm extends from a first hinge positioned on a distal end of a longitudinal edge of said solar bed cover to a first moving member of said solar bed cover, and further wherein said first moving member is configured to move along a first channel positioned on a first side wall of the bed of the truck.

12. The truck solar bed cover of claim 11, wherein said second hinged arm extends from a second hinge positioned on a distal end of another longitudinal edge of said solar bed cover to a second moving member of said solar bed cover, and further wherein said second moving member is configured to move along a second channel positioned on a second side wall of the bed of the truck.

13. The truck solar bed cover of claim 12, wherein movement of said first and said second moving members along respective said first channel and said second channel towards a front wall moves said solar bed cover to the inclined position.

14. The truck solar bed cover of claim 13, wherein movement of said first and said second moving members along respective said first channel and said second channel towards a rear wall moves said solar bed cover to the horizontal position.

15. The truck solar bed cover of claim 3, wherein said motorized hinge system comprises a control button mounted inside a cabin of the truck.

16. A truck solar bed cover comprising:
a solar bed cover spanning a bed of a truck;
a plurality of solar panels, wherein said plurality of solar panels absorb a solar energy and comprise a plurality of photovoltaic cells for converting the solar energy into an electric power and storing the electric power in a battery;
an aluminum frame for deploying above a cab of the truck, wherein said aluminum frame is retractable and foldable adjacent to said solar bed cover;
a power socket positioned inside the bed of the truck for drawing the electric power from said battery; and
further wherein said power socket is used for powering an electric power tool.

17. The truck solar bed cover of claim 16, wherein said solar bed cover comprises a motorized hinge system for moving said solar bed cover from a horizontal orientation to an inclined orientation, and further wherein said inclined orientation of said solar bed cover enables access to the bed of the truck.

18. A truck solar bed cover comprising:
a solar bed cover spanning a bed of a truck;
a plurality of solar panels to absorb a solar energy and comprising a plurality of photovoltaic cells for converting the solar energy into an electric power and storing the electric power in a battery;
a power socket positioned inside the bed of the truck for drawing the electric power from said battery; and
a hinge system for moving said solar bed cover from a horizontal orientation to an inclined orientation, wherein said inclined orientation of said solar bed cover enables access to the bed of the truck.

19. The truck solar bed cover of claim 18 further comprising an aluminum frame having additional solar panels for deploying above a cab of the truck, and further wherein said aluminum frame is retractable and foldable adjacent to said solar bed cover.

20. The truck solar bed cover of claim 19, wherein said aluminum frame is selectively removable from the truck.
